(19) United States
(12) Patent Application Publication
(10) Pub. No.: US 2024/0427268 A1
(43) Pub. Date: Dec. 26, 2024

(54) HEATER, FIXING DEVICE AND IMAGE FORMING APPARATUS

(71) Applicant: KYOCERA Document Solutions Inc., Osaka (JP)

(72) Inventors: Hiroki KAWASAKI, Osaka (JP); Ryohei TOKUNAGA, Osaka (JP); Akihiro KONDO, Osaka (JP); Yuta KITABAYASHI, Osaka (JP); Rina KIKUGAWA, Osaka (JP); Shunsaku FUJII, Osaka (JP); Yuto MASAOKA, Osaka (JP)

(73) Assignee: KYOCERA Document Solutions Inc., Osaka (JP)

(21) Appl. No.: 18/754,132

(22) Filed: Jun. 25, 2024

(30) Foreign Application Priority Data
Jun. 26, 2023 (JP) 2023-103951

(51) Int. Cl. G03G 15/20

(52) U.S. Cl. CPC G03G 15/2057; G03G 15/2064

(57) ABSTRACT

A heater heats a fixing belt in contact with an inner surface of the fixing belt. The fixing belt is formed into a cylindrical shape and rotates around an axis. The heater includes a substrate and a plurality of resistance heat generating elements. The substrate is made of insulator, and elongated in the axial direction. The resistance heat generating elements are arranged on one surface of the substrate facing the inner surface of the fixing belt with gaps in the axial direction, and generate heat by being supplied with power. A relationship between the gap G (mm) and a heat conductivity λ [W/m·K] of the inner surface of the fixing belt satisfies λ≥138G-36.

### INCORPORATION BY REFERENCE

This application is based on and claims the benefit of priority from Japanese patent application No. 2023-103951 filed on Jun. 26, 2023, which is incorporated by reference in its entirety.

### BACKGROUND

The present disclosure relates to a heater which heats a fixing belt, a fixing device and an image forming apparatus.

The fixing device which heats and fixes a toner image to a medium is provided with a heating member (a heater) which heats an endless belt by being contact with the inner surface of the endless belt. The heating member has a plurality of heat generating elements divided in a right angle direction orthogonal to a conveyance direction of the medium. The heat generating elements are arranged in an insulator, and a creeping distance of the insulator between the heat generating elements is longer than a distance between the heat generating elements. As a result, the adjacent heat generating elements are electrically insulated from each other, and a temperature drop of the endless belt at a portion corresponding to the gap between the heat generating elements is suppressed.

In order for the heating member to uniformly heat the endless belt, it is necessary to consider not only the gap between the heat generating elements but also a heat conductivity of the inner surface of the endless belt. Specifically, the gap can be widened as the heat conductivity of the inner surface of the endless belt increases. Since the heat conductivity of the inner surface of the endless belt is not sufficiently considered in the above technique, the required creeping distance cannot be ensured depending on the heat conductivity, or the temperature of the endless belt may be significantly lowered in the portion corresponding to the gap.

### SUMMARY

A heater according to the present disclosure heats a fixing belt in contact with an inner surface of the fixing belt. The fixing belt is formed into a cylindrical shape and rotates around an axis. The heater includes a substrate and a plurality of resistance heat generating elements. The substrate is made of insulator, and elongated in the axial direction. The resistance heat generating elements are arranged on one surface of the substrate facing the inner surface of the fixing belt with gaps in the axial direction, and generate heat by being supplied with power. A relationship between the gap G (mm) and a heat conductivity λ [W/m·K] of the inner surface of the fixing belt satisfies λ≥138G-36.

A fixing device according to the present disclosure includes a fixing belt, a pressure roller, and a heater. The fixing belt is formed into a cylindrical shape and heats a toner on a medium while rotating around an axis. The pressure roller rotates around an axis to form a pressurized region between the fixing belt and the pressure roller, and pressurizing the toner on the medium passing through the pressurized region. The heater heats the fixing belt in contact with an inner surface of the fixing belt facing the pressurized region. The heater includes a substrate and a polarity of resistance heat generating elements. The substrate is made of insulator, and elongated in the axial direction. The resistance heat generating elements are arranged on one surface of the substrate facing the inner surface of the fixing belt with gaps in the axial direction, and generate heat by being supplied with power. A relationship between the gap G (mm) and a heat conductivity λ [W/m·K] of the inner surface of the fixing belt satisfies λ≥138G-36.

An image forming apparatus according to the present disclosure includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (a front view) showing a printer according to one embodiment of the present disclosure.

FIG. 2 is a sectional view schematically showing a fixing device according to the embodiment of the present disclosure.

FIG. 3 is a bottom view schematically showing a heater of the fixing device according to the embodiment of the present disclosure.

FIG. 4 is a sectional view taken along the line IV-IV in FIG. 3.

FIG. 5 is a table showing a gap between heat generating elements, a heat conductivity of an inner surface of a fixing belt and an image quality of an image formed on a sheet.

FIG. 6 is a scatter diagram showing a relationship between the gap between the heat generating elements and the heat conductivity of the inner surface of the fixing belt.

### DETAILED DESCRIPTION

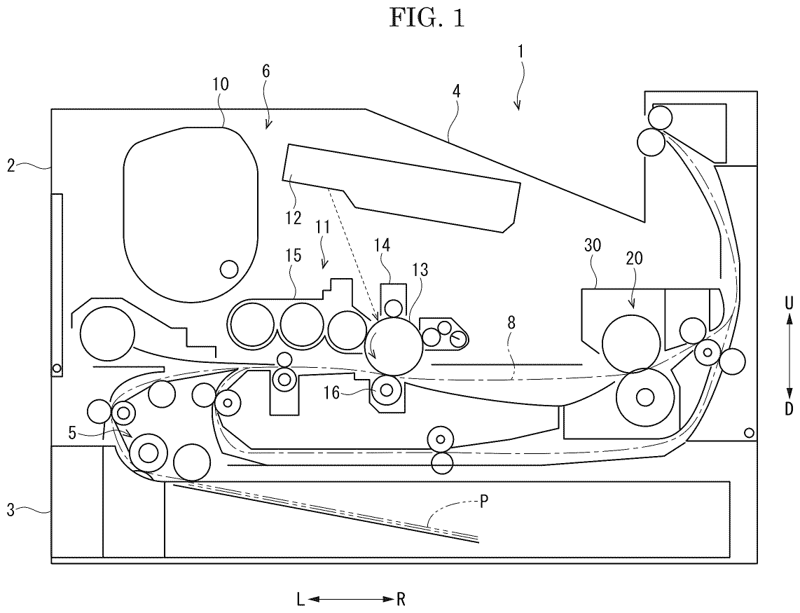

Hereinafter, with reference to the attached drawings, an embodiment of the present disclosure will be described. Fr, Rr, L, R, U, and D shown in the drawings indicate the front, rear, left, right, upper, and lower. Although directional and positional terms are used herein, they are used for convenience of description and do not limit the technical scope of the present disclosure.

[Entire Configuration of Printer] With reference to FIG. 1, a printer 1 as an example of the image forming apparatus will be described. FIG. 1 is a schematic view (a front view) showing the printer 1.

The printer 1 includes an apparatus body 2 constituting a substantially rectangular parallelepiped appearance. In the lower portion of the apparatus body 2, a sheet feeding cassette 3 in which a sheet P (the medium) is stored. On the upper surface of the apparatus body 2, a discharge tray 4 is provided. The sheet P is not limited to a paper sheet but may be made of resin or the like.

Inside the apparatus body 2, a conveyance path along which the sheet P is conveyed is formed. The conveyance path 8 is formed in a substantially S-shape between the sheet feeding cassette 3 and the discharge tray 4. A sheet feeding device 5 which feeds the sheet from the sheet feeding cassette 3 is provided at an upstream end of the conveyance path 8. An image forming device 6 is provided at an intermediate portion of the conveyance path 8, and a fixing device 20 is provided on the downstream side portion of the conveyance path 8.

The image forming device 6 includes a toner container 10, a drum unit 11, and an optical scanning device 12. The toner container 10 stores, for example, a black toner (a developer). The drum unit 11 includes a photosensitive drum 13, a charging device 14, a developing device 15, and a transfer roller 16. The charging device 14, the developing device 15 and the transfer roller 16 are arranged around the photosensitive drum 13 in the order of the image forming process. The transfer roller 16 is in contact with the photosensitive drum 13 from the lower side to form a transfer nip. The toner may be a two-component developer obtained by mixing the toner and the carrier, or may be a one-component developer containing a magnetic toner.

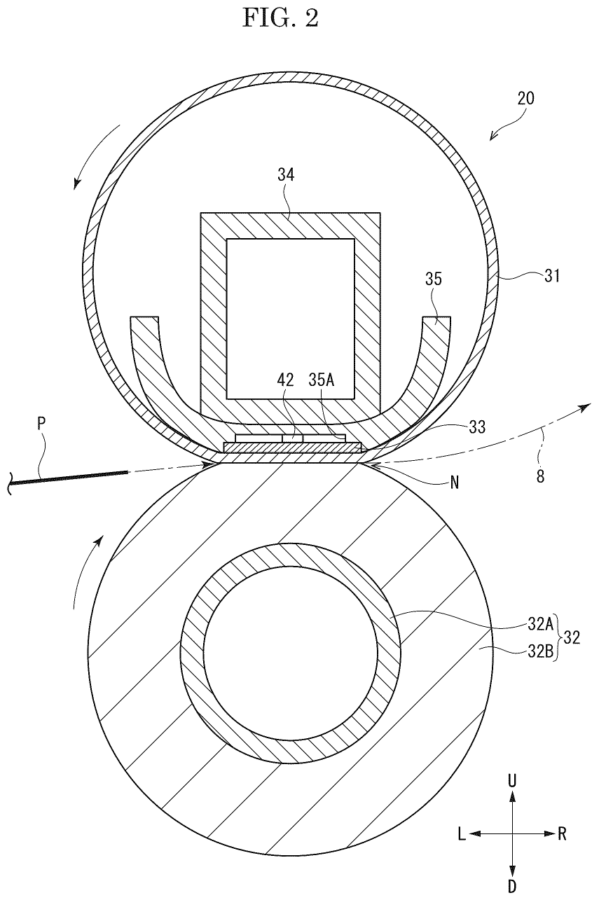

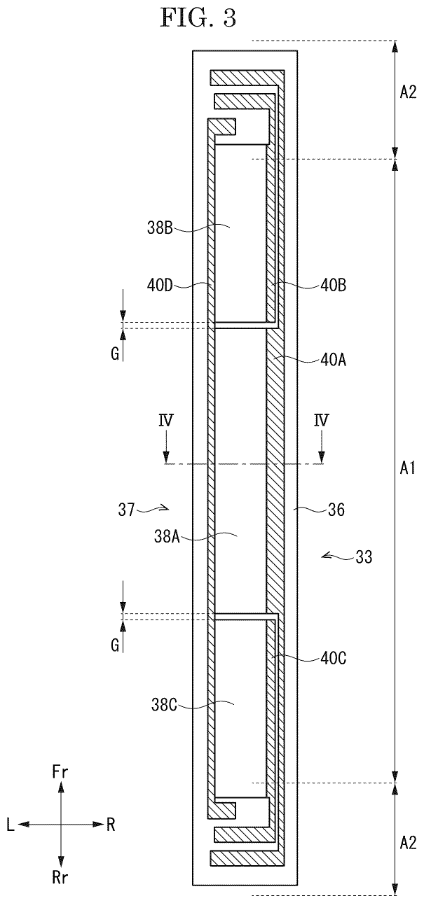

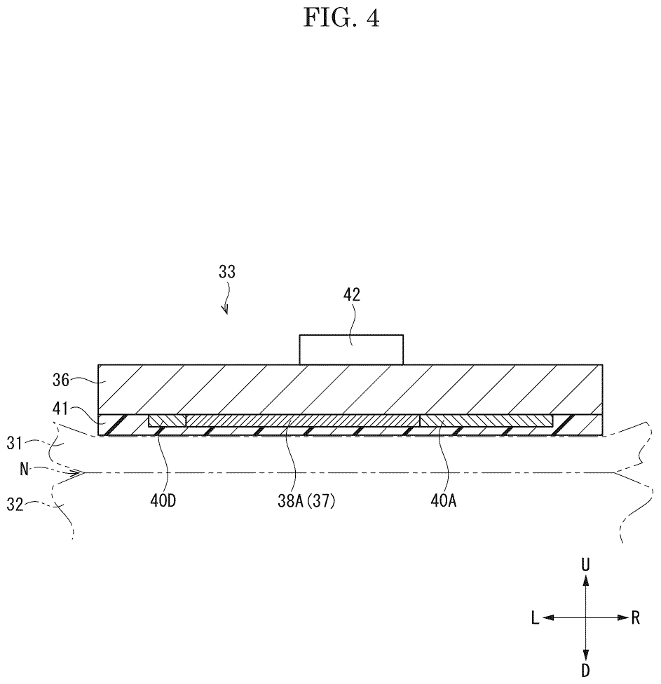

A control device (not shown) of the printer 1 controls each device appropriately and executes image forming process as follows. The charging device 14 charges the surface of the photosensitive drum 13. The photosensitive drum 13 is applied with scanning light emitted from the optical scanning device 12 and carries an electrostatic latent image. The developing device 15 develops the electrostatic latent image on the photosensitive drum 13 to a toner image using the toner supplied from the toner container 10. The sheet P is fed from the sheet feeding cassette 3 to the conveyance path 8 by the sheet feeding device 5, and the toner image on the photosensitive drum 13 is transferred to the sheet P passing through the transfer nip. The fixing device 20 heats and fixes the toner image to the sheet P. Thereafter, the sheet P is discharged to the discharge tray 4.

[Fixing Device] Next, the fixing device 20 will be described with reference to FIG. 2 to FIG. 4. FIG. 2 is a sectional view schematically showing the fixing device 20. FIG. 3 is a bottom view schematically showing a heater 33. FIG. 4 is a sectional view taken along the line IV-IV in FIG. 3.

As shown in FIG. 2, the fixing device 20 includes a fixing belt 31, a pressure roller 32, and a heater 33. The fixing belt 31 and the pressure roller 32 are provided inside the housing 30 (see FIG. 1). The heater 33 is provided inside the fixing belt 31.

<Fixing belt> The fixing belt 31 is an endless belt, and is formed in a substantially cylindrical shape elongated in the front-and-rear direction (the axial direction, the width direction). The fixing belt 31 is disposed in the upper portion of the inside of the housing 30. A pair of substantially cylindrical caps (not shown) are mounted on both the axial end portions of the fixing belt 31. A belt guide (not shown) for holding the substantially cylindrical shape of the fixing belt 31 may be provided inside the fixing belt 31.

The fixing belt 31 is made of synthetic resin material having heat resistance and elasticity. As a specific example, the fixing belt 31 is formed by laminating an outer layer made of PFA (perfluoroalkoxyalkane) on an inner layer made of polyimide. An intermediate layer made of silicon resin or the like may be formed between the inner layer (polyimide) and the outer layer (PFA).

(Pressing Member, Holding Member) A pressing member 34 and a holding member 35 are provided inside the fixing belt 31. The pressing member 34 is made of for example, metal material such as aluminum alloy or stainless steel, and is formed in an axially long substantially rectangular cylinder shape. The pressing member 34 penetrates the fixing belt 31 (and the caps) in the axial direction (the front-and-rear direction), and both the front and rear end portions of the pressing member 34 protruding from the fixing belt 31 are supported by the housing 30. The described above fixing belt 31 is rotatably supported with respect to the pressing member 34. The holding member 35 is, for example, made of heat-resistant resin material, and is formed in an axially long substantially semi-cylindrical shape. The holding member 35 is formed slightly shorter in the axial direction than the fixing belt 31, and is disposed inside the fixing belt 31. The holding member 35 is fixedly attached on the lower surface of the pressing member 34, and has a curved surface along the lower inner surface of the fixing belt 31. A fitting portion 35A into which the heater 33 is fitted is recessed in the lower portion of the holding member 35.

<Pressure Roller> The pressure roller 32 is formed in a substantially cylindrical shape elongated in the front-and-rear direction (the axial direction). The pressure roller 32 is disposed in the lower portion of the inside of the housing 30. The pressure roller 32 has a core metal 32A made of aluminum alloy, stainless steel or the like, and an elastic layer 32B made of silicone sponge or the like laminated on the outer circumferential surface of the core metal 32A. Both the axial end portions of the core metal 32A are rotatably supported by the housing 30. A drive motor (not shown) is connected to the core metal 32A via a gear train or the like, and the pressure roller 32 is driven by the drive motor to be rotated.

The fixing device 20 includes a pressure adjusting part (not shown) which adjusts the contact pressure of the pressure roller 32 with respect to the fixing belt 31 by lifting and lowering the pressure roller 32. When the pressure roller 32 is pressed against the fixing belt 31, a pressurized region N is formed between the fixing belt 31 and the pressure roller 32. The fixing belt 31 heats the toner on the sheet P passing through the pressurized region N while rotating around the axis, and the pressure roller 32 pressurizes the toner on the sheet P passing through the pressurized region N while rotating around the axis. The toner image is fixed on the sheet P by passing the sheet P through the pressurized region N. The pressurized region N refers to a region from an upstream position in the conveyance direction where the pressure is 0 Pa to a downstream position in the conveyance direction where the pressure is again 0 Pa via a position where the pressure becomes the maximum pressure. In this specification, “upstream” and “downstream” and similar terms refer to “upstream” and “downstream” and similar concepts in the conveyance direction of the sheet P.

The sheet P is conveyed with the center in the front-and-rear direction generally corresponding to the center of the pressurized region N in the front-and-rear direction (the axial direction). Therefore, in the fixing belt 31 (or the pressurized region N), a passing region A1, which is a center region in the axial direction and is in contact with the sheet P, and non-passing regions A2, which are both outer side regions in the axial direction and is not in contact with the sheet P, are set (see FIG. 3). Regardless of the size (the dimension in the front-and-rear direction) of the sheet P, the sheet P to be conveyed always comes into contact with the vicinity of the center of the passing region A1 in the axial direction. On the other hand, the sheet P of a normal size (for example, A4 size) comes into contact with both the outer sides of the passing region A1 in the axial direction, but the sheet P of a small size (for example, A5, B5 sizes) does not come into contact with the both the outer sides of the passing region A1.

<Heater> As shown in FIG. 2, the heater 33 is provided inside the fixing belt 31. Specifically, the heater 33 is fitted into the fitting portion 35A of the holding member 35, and is in contact with the inner surface of the fixing belt 31 facing the pressurized region N. The heater 33 heats the fixing belt 31 from the inside. As shown in FIG. 3 and FIG. 4, the heater 33 has a substrate 36 and a heating part 37.

(Substrate) The substrate 36 is made of, for example, (electrically insulating material) such as ceramic. The substrate 36 is formed in a substantially rectangular plate shape elongated in the axial direction corresponding to the fixing belt 31. The substrate 36 is formed slightly shorter in the axial direction than the fixing belt 31, and is arranged inside the fixing belt 31.

(Heating Part) The heating part 37 is provided on the lower surface (one surface) of the substrate 36, on the side of the inner surface of the fixing belt 31 (see FIG. 4). As shown in FIG. 3, the heating part 37 includes three resistance heat generating elements 38A to 38C arranged in a line with gaps G in the axial direction. Each of the three resistance heat generating elements 38A to 38C is made of metal material having a high electrical resistance value, and is formed in a substantially rectangular shape. The entire heating part 37 is formed shorter than the total length of the fixing belt 31 in the axial direction and longer than the passing region A1 of the fixing belt 31 in the axial direction. That is, both axial outer side portions of the resistance heat generating elements 38B and 38C disposed on both the axial outer sides face the non-passing regions A2 of the fixing belt 31. The resistance heat generating element 38A disposed in the axial center corresponds to the width of the small size sheet P in the front-and-rear direction, and all the resistance heat generating elements 38A to 38C correspond to the width of the normal size sheet in the front-and-rear direction. The resistance heat generating element 38A is an example of the center resistance heat generating element in the present disclosure, and the resistance heat generating elements 38B and 38c are examples of the end resistance heat generating element in the present disclosure. In the description common to the three resistance heat generating elements 38A to 38C, only arithmetic numerals are added to the marks.

Three individual electrodes 40A to 40C and a common electrode 40D are formed on the lower surface of the substrate 36 (see FIG. 3 and FIG. 4). The three individual electrodes 40A to 40C and the common electrode 40D are made of, for example, metal material having a lower electrical resistance than the resistance heat generating element 38. In this specification, in the description common to the three individual electrodes 40A to 40C and the common electrode 40D, it is simply referred to as “electrode part 40” and only arithmetic numerals are added to the marks.

As shown in FIG. 3, the individual electrode 40A is connected to the downstream end (the right end) of the resistance heat generating element 38A disposed in the axial center. The other individual electrodes 40B and 40C are connected to the downstream ends of the resistance heat generating elements 38B and 38C, respectively. The common electrode 40D is connected to the upstream ends (the left ends) of all the resistance heat generating elements 38A to 38C. Each of the electrode parts 40 extends from the portion connected to the heating part 37 to both axial outer sides of the heating part 37. The electrode parts 40 are electrically connected to an external device (not shown) such as a power source, on both the axial outer sides of the substrate 36.

The heating part 37 and the electrode part 40 are covered with a coat layer 41 (see FIG. 4). The coat layer 41 is made of material having an electrical insulating property and a small sliding friction force against the inner surface of the fixing belt 31, such as ceramic. The coat layer 41, the heating part 37, and the electrode part 40 can be accurately formed on the substrate 36 by, for example, a film forming technique such as sputtering, a circuit printed board manufacturing technique, a screen printing technique, or a combination of these techniques.

The heater 33 is fitted into the fitting portion 35A of the holding member 35 with the heating part 37 (the coat layer 41) facing the pressure roller 32, and the coat layer 41 is brought into contact with the inner surface of the fixing belt 31 (see FIG. 2 and FIG. 4). The heater 33 receives the fixing belt 31 pressed against the pressure roller 32, so that the pressurized region N is formed at the contact area between the fixing belt 31 and the pressure roller 32.

The fixing device 20 is provided with a temperature detecting part 42 which detects the temperature of the heater 33 and interrupts the power supply to the heater 33 when the temperature is an abnormal temperature. The temperature detecting part 42 is, for example, a thermosensitive element such as a thermocut, and is provided in contact with the heater 33. Specifically, the temperature detecting part 42 is attached to the top surface of the fitting portion 35A of the holding member 35, and the lower portion of the temperature detecting part 42 is brought into contact with the upper surface of the substrate 36 (see also FIG. 2). The temperature detecting part 42 is in contact with the slightly rear portion of the substrate 36 in the axial direction (not shown).

[Operation of the Fixing Device] Here, the operation (the fixing process) of the fixing device 20 will be briefly described. The electrode part 40 of the heater 33, the drive motor, and the like are electrically connected to a power source (not shown) and the control device through various drive circuits (not shown).

The control device drives and controls the drive motor and the heater 33. The pressure roller 32 is rotated under the driving force of the drive motor, and the fixing belt 31 is rotated in accordance with the pressure roller 32 (see the solid thin arrow in FIG. 2). The heating part 37 (each resistance heat generating element 38) is supplied with the power through the electrode part 40 to generate heat, and the fixing belt 31 (the pressurized region N) is heated.

At this time, the control device changes the resistance heat generating elements 38A to 38C to be heated (supplied with the power) according to the size of the sheet P. For example, when the normal size sheet P passes through the pressurized region N, the control part performs control to heat all the resistance heat generating elements 38A to 38C. When the small size sheet P passes through the pressurized region N, the control part performs control to generate heat from one resistance heat generating element 38A. Thus, only the necessary area of the fixing belt 31 (the pressurized region N) can be heated according to the size of the sheet P. As a result, the power used can be minimized. It is also possible to suppress the excessive temperature increase at both the axial end portions of the fixing belt 31.

When the temperature of the fixing belt 31 reaches the set temperature, the image forming operation described above is started. While the sheet P on which the toner image is transferred passes through the pressurized region N, the toner image is pressurized and fixed to the sheet P while being heated.

By the way, the three resistance heat generating elements 38 arranged in a line in the axial direction must be electrically insulated from each other. Therefore, a creeping distance necessary for insulation is defined on the substrate 36 (insulator) exposed between the adjacent resistance heat generating elements 38 in the axial direction. When the creeping distance is increased (lengthened) in order to ensure the electrical insulation, the distance (hereinafter referred to simply as “gap G”) between the axially adjacent resistance heat generating elements 38 is also increased (lengthened). In this embodiment, the creeping distance [mm] is substantially the same as the gap G [mm]. As the gap G becomes larger (longer), the problem that the temperature of the fixing belt 31 decreases at the position corresponding to the gap G becomes remarkable. As a result, the temperature of the fixing belt 31 (the pressurized region N) becomes uneven in the axial direction, and a proper heating fixing may not be performed.

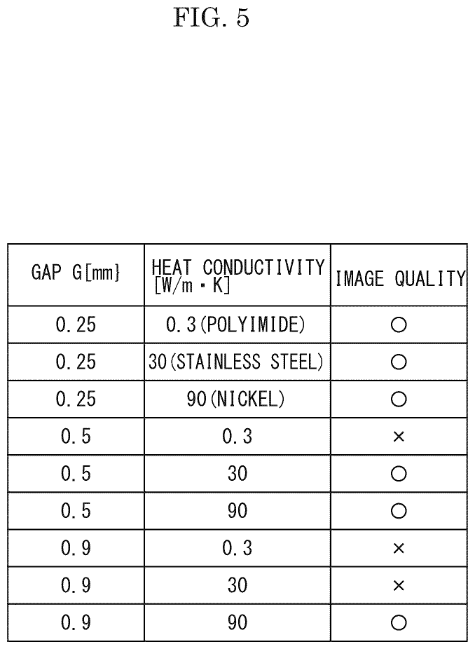

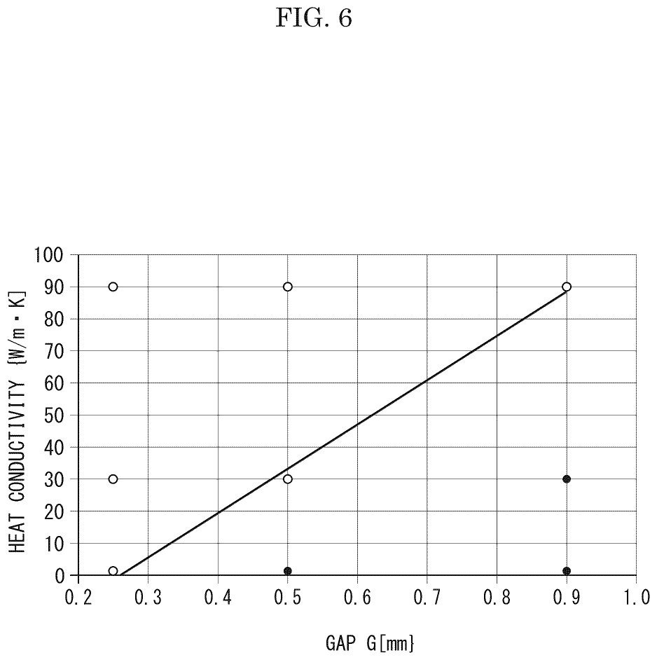

Further, in order for the heater 33 to uniformly heat the fixing belt 31 in the axial direction, it is necessary to consider not only the gap G but also a heat conductivity λ [W/m·K] (hereinafter referred to simply as “heat conductivity λ”) of the inner surface (the material constituting the inner layer) of the fixing belt 31. For example, when the inner surface of the fixing belt 31 is made of metal (stainless steel, nickel, or the like) having a high heat conductivity λ, the fixing belt 31 is easily heated, so that the gap G can be widened. On the other hand, when the inner surface of the fixing belt 31 is made of synthetic resin (polyimide, or the like) having a low heat conductivity λ, since the fixing belt 31 is difficult to be heated, if the gap G is widened, the temperature is not uniform in the axial direction, and temperature spots are easily formed. Therefore, when a heat conductivity λ of the inner surface of the fixing belt 31 is low, it is required to narrow the gap G while securing the electrical insulation state described above. However, since it is necessary to secure the creeping distance described above, there is a limit to narrowing the gap G. In this specification, the term “uniform” does not mean only a state that is completely constant, but also means to have a slight allowance.

[Experiment] The applicant carries out an experiment to confirm a relationship between the gap G and a thermal conductivity λ in order to heat the fixing belt 31 uniformly in the axial direction while securing the required creeping distance. With reference to FIG. 5 and FIG. 6, the experiment carried out by the applicant and the results of the experiment will be described. FIG. 5 is a table showing the gap G, the heat conductivity λ and the image quality of the image formed on the sheet P. FIG. 6 is a scatter diagram showing the relationship between the gap G and the heat conductivity λ.

The applicant uses three kinds of fixing belts 31 whose inner surfaces (the inner layers) are made of different materials and three kinds of heaters 33 having different gaps G between the resistance heat generating elements 38, forms an image on the sheet P, and evaluates the state of the image (see FIG. 5). The materials of the inner surfaces (the inner layers) of the three kinds of fixing belts 31 are polyimide (λ=0.3 W/m·K), stainless steel (λ=30 W/m·K), and nickel (λ=90 W/m·K). The gaps G of the resistance heat generating elements 38 of the three kinds of heaters 33 are 0.25 mm, 0.5 mm, and 0.9 mm. The applicant visually checks whether there is a defect such as gloss streaks or peeling of the image, and a case where it is checked that there is a defect, it is shown by “x”, and a case whether it is checked that there is no defect (good), it is shown by “o”.

As shown in FIG. 5, when the gap G is set to 0.25 mm, no defective image is observed in any of the three kinds of fixing belts 31 (a good image is obtained). When the gap G is set to 0.5 mm, a defective image is not observed in the fixing belt 31 whose inner surface is made of stainless steel and nickel, but a defective image is observed in the fixing belt 31 whose inner surface is made of polyimide. When the gap G is set to 0.9 mm, a defective image is not observed in the fixing belt 31 whose inner surface is made of nickel, but a defective image is observed in the fixing belt 31 whose inner surface is made of stainless steel and polyimide.

FIG. 6 is a scatter diagram with the horizontal axis as the size of the gap G and the vertical axis as the value of the heat conductivity λ based on the results shown in FIG. 5. In FIG. 6, a straight line (approximate line) is drawn as a boundary between points at which a good image is obtained (see white filled circles) and points at which a defect image is observed (see black filled circles). This line is represented by λ=138G-36. Considering the above experimental result (FIG. 5 and FIG. 6), it is considered that a good image can be obtained when the gap G and the heat conductivity λ are set in a range equal to or larger than the straight line, and a defect image is be obtained when they are set in a range less than the straight line. That is, by setting the gap G and the heat conductivity λ to satisfy λ≥138G-36, it is confirmed that the fixing belt 31 can be uniformly heated in the axial direction while securing the necessary creeping distance.

In the heater 33 (the fixing device 20) according to the embodiment described above, the relationship between the gap G [mm] between the adjacent resistance heat generating elements 38 in the axial direction and the heat conductivity λ [W/m·K] of the inner surface of the fixing belt 31 satisfies λ≥138G-36. According to this configuration, an appropriate gap G can be determined by determining the inner surface material (the heat conductivity λ) of the fixing belt 31. Thus, the adjacent resistance heat generating elements 38 can be electrically insulated from each other, and the temperature drop of the fixing belt 31 at the portion corresponding to the gap G between the resistance heat generating elements 38 can be suppressed. As a result, the fixing belt 31 can be uniformly heated in the axial direction while securing the necessary creeping distance in the substrate 36 (the insulator) corresponding to the gaps G.

In addition, according to the fixing device 20 according to the present embodiment, by using polyimide as the inner surface material of the fixing belt 31, the fixing belt 31 can be formed more light and more inexpensive than the case using metal such as stainless steel or nickel. Since the heat conductivity λ of the polyimide is lower than the heat conductivity λ of the metal, the gap G between the resistance heat generating elements 38 is narrower, but the creeping distance required can be secured by satisfying the above formula.

In the fixing device 20 according to the present embodiment, the inner surface (the inner layer) of the fixing belt 31 is made of polyimide, but the present disclosure is not limited thereto. The inner surface (the inner layer) of the fixing belt 31 may be made of metal such as stainless steel or nickel. Even in this case, the gap G and the heat conductivity λ may be set to satisfy λ≥138G-36.

In the fixing device 20 according to the present embodiment, the heating part 37 is divided into three resistance heat generating elements 38A to 38C, but the present disclosure is not limited thereto. The heating part 37 may be divided into two or more resistance heat generating elements 38 (not shown).

In the fixing device 20 according to the present embodiment, the sheet P passes through the center of the pressurized region N in the axial direction, but it is not limited to this, and the sheet P may pass through a position on one side of the pressurized region N in the axial direction. In this case, the non-passing region A2 is set only on one side in the axial direction of the fixing belt 31 (or the pressurized region N).

In the fixing device 20 according to the present embodiment, the pressure roller 32 is driven by the motor to be rotated and the fixing belt 31 is driven by the pressure roller 32 to be rotated; however, the fixing belt 31 may be driven to be rotated and the pressure roller 32 may be driven by the fixing belt 31 to be rotated. Although the pressure roller 32 is moved upward and downward (moved in the directions of approaching or separating from the fixing belt 31) with respect to the fixing belt 31, the fixing belt 31 may be moved in the directions of approaching or separating from the pressure roller 32 (not shown).

Although the description of the present embodiment shows a case where the present disclosure is applied to the monochrome printer 1, the present disclosure may be applied to, for example, a color printer, a copying machine, a facsimile machine or a multifunctional peripheral.

The description of the above embodiment shows one aspect of the heater, the fixing device and the image forming apparatus according to the present disclosure, and the technical scope of the present disclosure is not limited to the above embodiment. The present disclosure may be variously changed, substituted, or modified to the extent that it does not deviate from the purport of technical thought, and the claims include all embodiments that may be included within the scope of technical thought.

1. A heater heating a fixing belt in contact with an inner surface of the fixing belt, in which the fixing belt is formed into a cylindrical shape and rotates around an axis, the heater comprising:
a substrate made of insulator, and elongated in the axial direction; and
a plurality of resistance heat generating elements arranged on one surface of the substrate facing the inner surface of the fixing belt with gaps in the axial direction, and generating heat by being supplied with power, wherein
a relationship between the gap G (mm) and a heat conductivity λ [W/m·K] of the inner surface of the fixing belt satisfies λ≥138G-36.

2. A fixing device comprising:
a fixing belt formed into a cylindrical shape and heating a toner on a medium while rotating around an axis;
a pressure roller rotating around an axis to form a pressurized region between the fixing belt and the pressure roller, and pressurizing the toner on the medium passing through the pressurized region; and
a heater heating the fixing belt in contact with an inner surface of the fixing belt facing the pressurized region, wherein
the heater includes:
a substrate made of insulator, and elongated in the axial direction; and
a plurality of resistance heat generating elements arranged on one surface of the substrate facing the inner surface of the fixing belt with gaps in the axial direction, and generating heat by being supplied with power, wherein
a relationship between the gap G (mm) and a heat conductivity λ [W/m·K] of the inner surface of the fixing belt satisfies λ≥138G-36.

3. The fixing device according to claim 2, wherein
the resistance heat generating elements includes a center resistance heat generating element having a width corresponding to a small size medium and two end resistance heat generating elements on outer sides of the center resistance heat generating element in the axial direction, and
the gaps are formed between the center resistance heat generating element and the end resistance heat generating elements.

4. The fixing device according to claim 3, wherein
the inner surface of the fixing belt is made of polyimide.

5. An image forming apparatus comprising the fixing device according to claim 2.
